(19) United States
(12) Patent Application Publication
(10) Pub. No.: US 2025/0161773 A1
(43) Pub. Date: May 22, 2025

(54) VIBRATION DAMPENING TAPE FOR ATTACHING A GRIPPING MEMBER AND METHOD OF USE

(71) Applicant: VT Advantec, L.L.C., Chicago, IL (US)

(72) Inventor: Larry Condez, Jr., Chicago, IL (US)

(21) Appl. No.: 18/836,151

(22) PCT Filed: Feb. 7, 2023
(86) PCT No.: PCT/US2023/062156

§ 371 Date: Aug. 6, 2024

Related U.S. Application Data
(60) Provisional application No. 63/307,928, filed on Feb. 8, 2022.

(51) Int. Cl. A63B 60/08; A63B 53/14; A63B 60/54; A63B 102/32; B29C 65/50; B29K 661/00; B29L 31/52

(52) U.S. Cl. CPC A63B 60/08; A63B 53/14; A63B 60/54; B29C 65/50; A63B 2102/32; A63B 2209/10; B29K 2661/00; B29K 2995/007; B29L 2031/5227

(57) ABSTRACT

A vibration dampening tape for attaching a gripping member and method of use is provided. More particularly vibration dampening tape including a layered strip with a polymeric core.

The present application claims the benefits of and priority to U.S. Provisional Patent Application No. 63/307,928, filed Feb. 8, 2022, which is hereby incorporated herein by reference.

### FIELD OF THE INVENTION

This disclosure generally relates to sporting equipment including a vibration dampening element, wherein the vibration dampeners dampen or attenuate energy. More particularly, this disclosure relates to vibration dampening tapes for attaching a grip to a handle of a sporting equipment.

### BACKGROUND

Several types of sports equipment are used for striking, hitting and/or absorbing impact. It is oftentimes desired to dampen excess energy during use of the sports equipment to protect the user. While a variety of materials cater to such needs for attenuation and absorption, an unfulfilled need exists for a material that will provide an improvement in attenuation and absorption of impact and vibration for sporting equipment.

Therefore, there remains a need for methods and devices that attenuate and/or dampen energy during the use of sporting equipment.

### SUMMARY OF INVENTION

In one aspect, a sports equipment includes a shaft with a proximal end and a distal end, a handle located at the proximal end of the shaft, a gripping member placed over the handle, and a vibration dampening element. The vibration dampening element includes a vibration dampening polymer layer and is located between the handle and gripping member.

In another aspect, a golf club includes a shaft with a proximal end and a distal end, a handle located at the proximal end of the shaft, a club located at the distal end of the shaft, a gripping member placed over the handle, and a vibration dampening element. The vibration dampening element includes a vibration dampening polymer layer and is located between the gripping member and the handle.

In yet another aspect, a method for applying a gripping member to a sports equipment includes applying a vibration dampening element to a handle of the sports equipment. The vibration dampening element includes a polymer layer with a first side and a second opposing side, a first adhesive layer over the first side of the polymer layer and a second adhesive layer over the second side of the polymer layer, wherein the first adhesive layer is configured to adhere to the handle of the sports equipment and the second adhesive layer is configured to adhere to the gripping member. The method also includes applying a solvent on the second adhesive layer and sliding the gripping member over the vibration dampening element. The solvent is dried to adhere the vibration dampening element to an inside surface of the gripping member.

### BRIEF DESCRIPTION OF DRAWINGS

FIG. 1 is an enlarged side view of an embodiment of the vibration dampening element;

FIG. 1A is a top view of the vibration dampening element of FIG. 1;

FIG. 2 is an enlarged side view of another embodiment of the vibration dampening element;

FIG. 3 is a side view of a roll of the vibration dampening element with an inset of an enlarged side view of an embodiment of the vibration dampening element;

FIG. 4 is a perspective view of a sporting equipment having a vibration dampening element on the shaft of the equipment;

FIG. 5 is a side view of a sporting equipment having a vibration dampening element wound around a shaft of the equipment;

FIG. 6 is a perspective view illustrating a shaft of a sporting equipment having a vibration dampening element thereon and a gripping member prior to placing the gripping member onto the shaft; and

FIG. 7 is a side view showing the shaft having the vibration dampening element thereon and the shaft partially inserted into a gripping member.

### DETAILED DESCRIPTION

Turning to the figures, the present disclosure is directed towards a vibration dampening element for sports equipment. The vibration dampening element may dampen and/or attenuate vibrations and/or other forms of energy that are generated during use of the sports equipment. Dampening such vibrations provides a user more comfort, stability, and a feeling of a crisp impact when using the sports equipment.

In one alternative, the dampening element is a vibration dampening tape that is used to attach a gripping member to a sporting equipment. Such sport equipment includes, but is not limited to, racquets (tennis, racquet ball, badminton etc.) paddles (ping-pong, pickleball, tennis, platform tennis, etc.), sticks (hockey, lacrosse, etc.), clubs (golf, etc.), bats (baseball, softball, cricket, etc.).

In one embodiment, the vibration dampening element is associated with a shaft of a sports equipment. The dampening element includes a polymeric composition. In one embodiment, the polymeric composition may be a composition comprising a butyl rubber, such as any of the butyl rubber containing polymeric composition disclosed herein. In an alternative embodiment, the polymeric composition could be any polymer composition that dampens or attenuates energy so as to reduce the vibration and frequency during use, therefore enhancing the user's experience of the sports equipment. For example, the polymeric composition could include any suitable polymer. Optionally, the polymeric composition may include other components as well. In one embodiment, the polymeric composition may include a polymer and a metal. For example, the polymeric composition may include a polymer and tungsten. In one embodiment, the polymeric composition may include polyether block amide and tungsten. In other embodiments, the polymeric composition could include Aflas, Chlorosulfonated Polyethylene, Epichlorohydrin, Ethylene Propylene, Fluoroelastomer, Fluorosilicone, Hydrogenated Nitrile, Natural Rubber, Nitrile, Perfluoroelastomer, Polyacrylic, Polychloroprene, Polyurethane, Silicone, Styrene Butadeine, Foam, Plastics, Sheet Stock, Moon Gels, Aero Gels, Basalt, and Tungsten.

The dampening element may be a vibration dampening tape that is used to attach a gripping member to the shaft or handle of a sporting equipment. The vibration dampening tape includes a layer of the vibration dampening polymeric composition and one or more layers of adhesive. The vibration dampening tape is located between the shaft and gripping member. The adhesive of the vibration dampening tape adheres to the shaft and the gripping member, thereby attaching the gripping member to the shaft.

The vibration dampening tape may be in the form of a strip or a sheet. The strip may be an elongated, narrow strip that is longer than it is wide. The strip may be pre-cut into a desired size. Alternatively, the strip may be provided on a roll wherein the user may custom cut the strip to a desired size. When in a sheet, the sheet may be configured to cover a relatively larger size than a strip. The sheets may be regular or irregular shapes. For example, the sheets may be square, rectangular, circular, oval, etc. or the sheets may be in a custom shape or be configured to be cut into a custom shape.

In one embodiment, the dampening element may be a layered vibration dampening tape that includes the layer of the polymer composition with opposing first and second sides and an adhesive layer over one of the opposing sides for attaching the tape to the shaft of the sports equipment. Additionally, the dampening element may include an adhesive layer over the other of the opposing sides for attaching the strip or tape to a gripping member.

The adhesive layer may be a double-sided adhesive layer applied over an opposing side of the polymer layer. The double-sided adhesive layer may be paper-based or tissue-based. For example, the adhesive layer may include a paper or tissue sub-layer, wherein a pressure sensitive adhesive is applied to each side of the paper/tissue sub-layer. The pressure-sensitive adhesive may be a solvent-based acrylic adhesive. An example of a suitable adhesive is the DCT080A Medium Grade Double-Coated Tissue sold by Intertape Polymer Group® located in Sarasota, FL. Optionally, the adhesive layer may include adhesive on one side of the sub-layer. The non-adhesive side of the sub-layer may be adhered to the surface of the polymer layer by methods known in the art, including, but not limited to hot melt, gluing, meshing, welding, etc. Other adhesive layers may be used without departing from the scope of the disclosure. Optionally, the adhesive layer may be an adhesive directly applied to the polymer layer. For instance, the adhesive may be sprayed or painted directly to the surface of one or both sides of the polymer layer.

A gripping member may be placed over the adhesive layer of the vibration dampening tape. The gripping member assists in the user gripping the sports equipment. The gripping member may be, for example, real or synthetic leather, a polymer layer, or synthetic polymer layer. The gripping material may have an outer surface that is intended to be gripped by a user's hand. The outer surface may be textured or tacky to assist in gripping. In one embodiment, an adhesive layer may be between the gripping member and the layer of the polymer composition. In some embodiments, the gripping member may be an elongated strip that is wrapped around the adhesive layer. In other embodiments, the gripping member may be a sleeve that has a bore for receiving a portion of the sports equipment. The gripping member may be configured to be positioned over a handle or shaft of the sporting equipment.

Optionally, a plurality of strips or sheets of the vibration dampening tape may be used to attach a gripping member. The strips or sheets may be located at different locations on the shaft of the sports equipment.

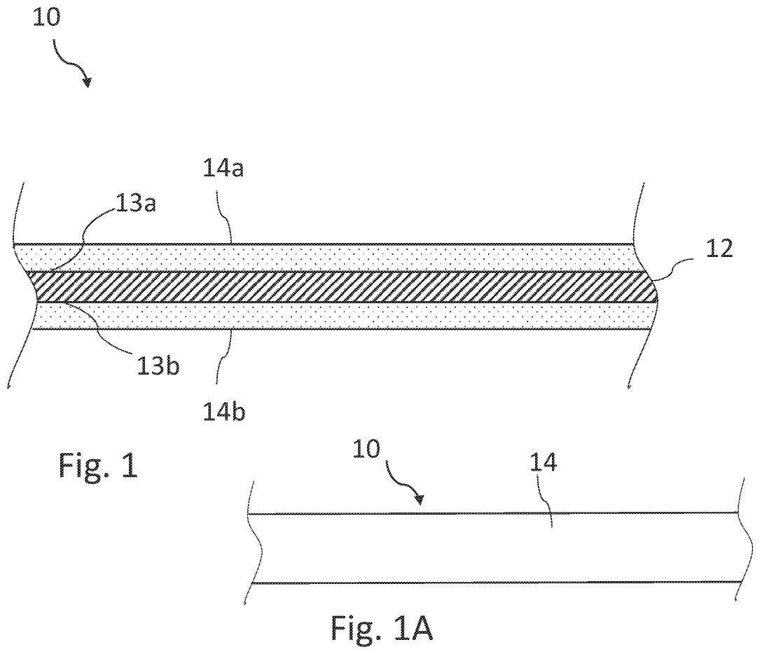

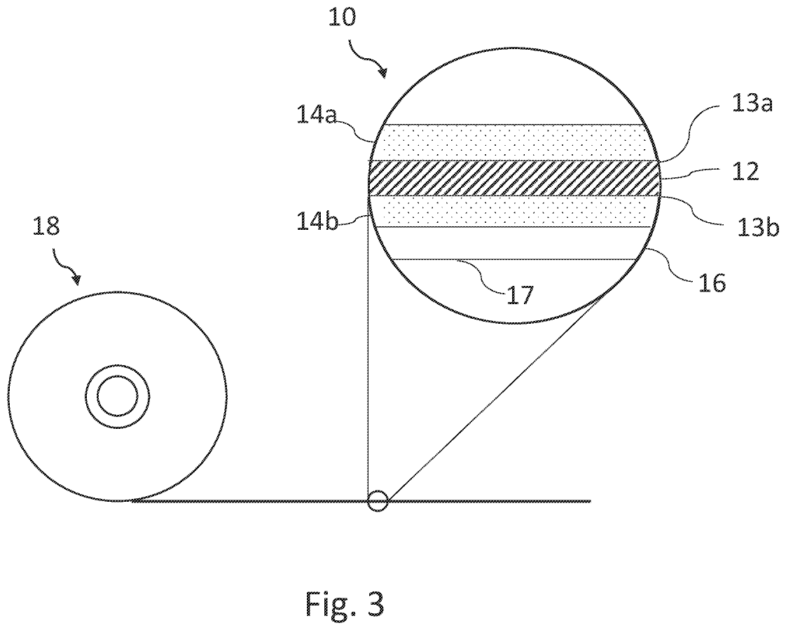

Turning to FIGS. 1 and 1A, there is shown an exemplary embodiment of a vibration dampening tape 10. In this example, the dampening tape 10 is a layered element. The vibration dampening tape 10 may be provided in a strip, sheet, or roll. In one embodiment, a strip could be provided as individual precut strips or could be provided as a roll or tape (shown in FIG. 3), wherein the user may custom cut the strips to size. Referring to FIG. 1, the dampening tape 10 includes a layer of polymeric composition 12. The layer of polymer 12 includes a first side 13a and a second opposing side 13b. The polymer layer may have a thickness between about 10 mil and about 16 mil. The layer of polymeric composition 12 may include a polymeric composition, such as any of those disclosed herein. In one embodiment, the polymeric composition may contain butyl rubber, such as any of the butyl rubber compositions disclosed herein.

The vibration dampening tape 10 may include an adhesive layer 14a for attaching the dampening tape 10 to sports equipment or a gripping member. Optionally, the vibration dampening tape 10 may include two adhesive layers 14a and 14b. The adhesive layers 14a and 14b, may be any of the adhesive layers described herein, such as the adhesive layer described above, or any other suitable adhesive layers. In some embodiments, adhesive layers 14a and 14b are included on each opposing side 13a and 13b, respectively, of the layer of polymeric composition 12. The adhesive layer 14a may be attached to the sporting equipment and the adhesive layer 14b may be attached to the gripping member, thereby attaching the gripping member to the sporting equipment.

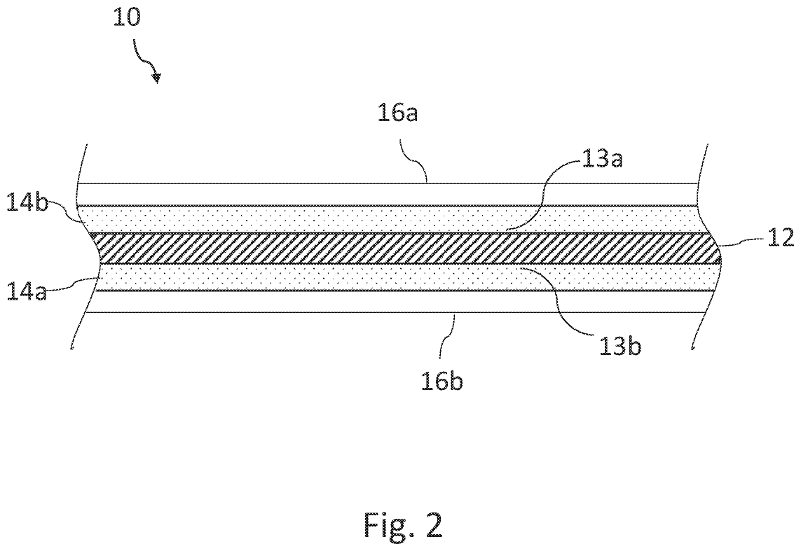

As seen in FIG. 2, when an adhesive layer 14 is included, the vibration dampening tape 10, optionally, may also include release layer(s) or liner(s) 16a and 16b over the exposed surfaces of each of the adhesive layers 14a and 14b. The release liners 16a and 16b are removed to apply the vibration dampening tape 10 to the sports equipment, the gripping member, or both.

Optionally, the vibration dampening tape 10 could include a backing layer (not shown) over one of the opposing sides 13a,13b of the polymeric composition layer 12. The backing layer could be to protect the polymer material and/or could include decorations, sayings or images.

Turning to FIG. 3, there is shown a vibration dampening tape 10 provided in a roll 18. In this example, the vibration dampening tape 10 includes a layer of polymeric composition 12 with a first opposing side 13a and a second opposing side 13b. The polymeric composition may include a polymeric composition, such as any of those disclosed herein. The dampening element further includes adhesive layers 14a and 14b on top of both the first and second opposing sides 13a, 13b, respectively, of the polymer layer 12. The vibration dampening element includes a release layer or liner 16 over adhesive layers 14b. As the vibration dampening tape 10 is rolled, the exposed adhesive layer 14a will contact a top surface 17 of the release liner 16 placed on top of the other adhesive layer 14b. This will prevent the vibration dampening tape 10 from adhering to itself when rolled up. A user may then unroll the vibration dampening tape 10 and may custom cut the roll into strips. In one embodiment, the rolls may include a vibration dampening tape 10 with a length of 36 to 72 yards and a width of 0.75 to 2 inches. Other lengths of the vibration dampening tape 10 intended to be rolled may be used without departing from the scope of the disclosure.

The strips may be virtually any length and width depending on the desired use and the sports equipment to which it is attached. In one embodiment, the strip has a length of about 10 inches and a width between about 0.75 inches and 2 inches.

The polymer material of the vibration dampening tape 10 described below may be any of the polymer materials disclosed herein (such as the butyl rubber materials) and may have one or more of the following:
Tensile Strength between about 600 psi/min and about 800 psi/min, as measured by ASTM D412. Preferably between about 680 psi/min and about 750 psi/min, and more preferably about 722 psi/min.
Elongation between about 900% and 1000%, as measured by ASTM D412. Preferably between about 950% and about 997%, and more preferably about 985%.
Tear Strength between about 100 pli and about 200 pli, as measured by ASTM D624. Preferably between about 110 pli and about 135 pli, and more preferably about 129 pli.
Shore A Hardness between about 40 and about 55, as measured by ASTM D2240. Preferably between about 44 and about 55, and more preferably about 53.
Bashore Rebound between about 3% and about 7%, as measured by ASTM D2632. Preferably between about 4% and about 6%, and more preferably about 5%.
Ultimate Tensile Strength between about 900 psi/min and about 1000 psi/min, as measured by ASTM D412. Preferably between about 970 psi/min and about 990 psi/min, and more preferably about 985 psi/min.
Ultimate Elongation between about 680% and 740%, as measured by ASTM D412. Preferably between about 700% and about 730%, and more preferably about 722%.

In one embodiment, the polymer layer 12 of the vibration dampening tape 10 and/or the strips disclosed above may be any of the polymer materials disclosed (such as the butyl rubber materials) herein and may have one or more of the following:
Shore A Hardness between about 45 and about 75, as measured by ASTM D2240. Preferably between about 55 to about 65, and more preferably about 60.
Tensile Strength between about 1,050 psi/min and about 1950 psi/min, as measured by ASTM D412. Preferably between about 1,400 psi/min to about 1,600 psi/min, and more preferably about 1,500 psi/min.
Elongation of between about 300% and 400%, as measured by ASTM D412. Preferably between about 325% to 375%, and more preferably about 350%.

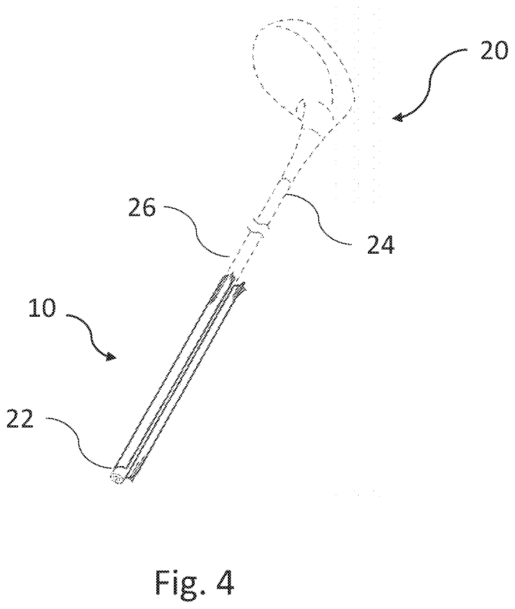

Turning now to FIG. 4, this figure provides an example of a vibration dampening tape 10 being attached to sports equipment, such as the illustrated golf club 20. The size, number and placement of the vibration dampening tape 10 on the sports equipment may be customizable. That is, the size of the vibration dampening tape 10 could be virtually any size, the number of dampening tapes could be any number, and the dampening tapes(s) could be placed at any location along the shaft or handle of the golf club. In FIG. 4, golf club 20 includes a proximal end 22 and a distal end 24. A dampening tape 10 is attached to proximal end 22 of shaft 26 of golf club 20. Optionally, a dampening tape 10 may be placed on a handle located on the proximal end 22 of a golf club 20.

In one embodiment, a single strip of the vibration dampening tape 10 may be wrapped around the golf club 20. The vibration dampening tape 10 may be cut into a strip and wrapped around the golf club 20 in an orientation where the length of the strip is parallel with the length of the shaft 26 of the golf club 20. In other embodiments, two strips of the vibration dampening tape 10 may be adhered to opposite sides of the shaft 26, sandwiching the shaft 26 between the dampening elements 10.

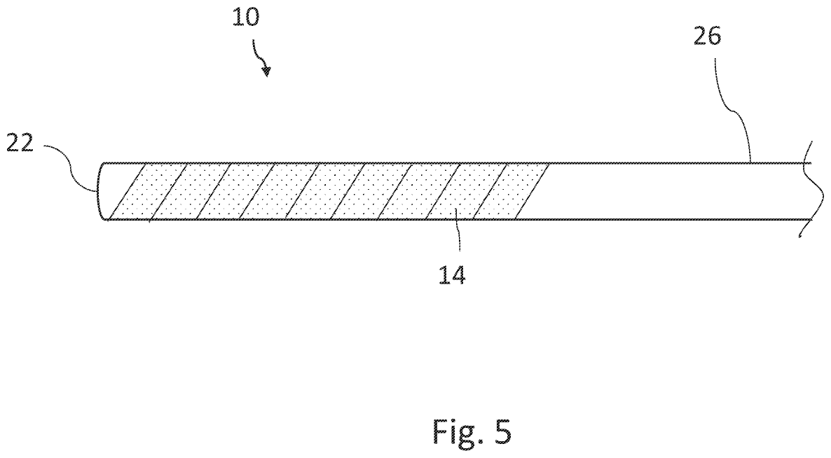

As seen in FIG. 5, the vibration dampening tape 10 may also be wound around a shaft 26 of a sports equipment in an angled fashion. The dampening tape 10 may be cut into a strip and wrapped around a shaft 26 with the length of the strip substantially perpendicular to the length of the shaft 26.

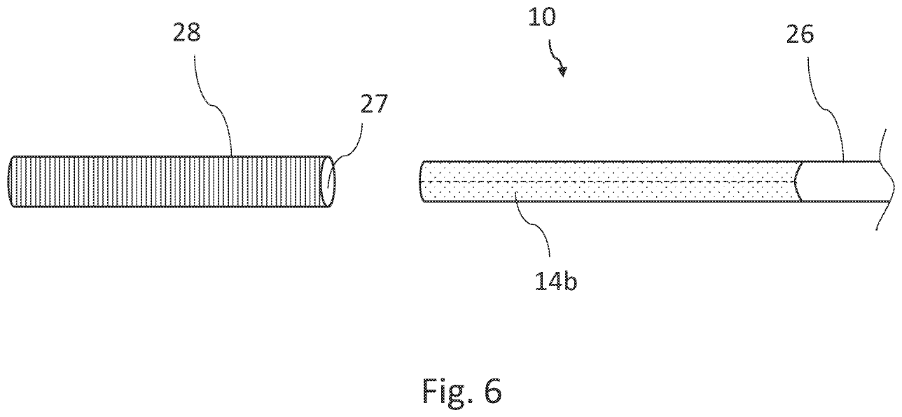

Turning now to FIG. 6, there is shown a vibration dampening tape 10 adhered to a shaft 26 of a sports equipment and a gripping member 28. Vibration dampening tape 10 may be used to adhere a gripping member 28 to a sports equipment. Vibration dampening tape 10 could be provided as a strip, sheet, or tape. The dampening tape 10 includes a layer of polymeric composition 12 (FIGS. 1 and 2) with opposing first and second sides 13a, 13b (FIGS. 1 and 2). The dampening tape 10 further includes a first and second adhesive layer 14a (FIGS. 1 and 2) and 14b over each of the opposing sides 13a, 13b of the polymer layer 12. The vibration dampening tape 10 may be attached to the surface of a handle or shaft 26 of a sports equipment by applying a first adhesive layer 14 to the shaft 26.

In an embodiment where a layer of adhesive 14 is not present, the polymeric composition layer 12 may be applied directly to the surface of the sporting good. For example, the polymer composition, such as the butyl rubber compositions disclosed herein, may have sufficient tack so that the vibration dampening tape 10 (strip, sheet or tape) can be applied directly to the surface of the sporting good without the use of an intervening adhesive layer. That is, the polymer composition may have sufficient tackiness such that when employed without an adhesive layer, the dampening tape 10 sufficiently attaches, sticks, or is mounted on the sporting good.

After applying a first adhesive layer 14a to the sports equipment, a solvent may be applied to the exposed second adhesive layer 14b. The solvent temporarily reduces the tackiness of the adhesive layer 14b so that layer 14b is more lubricious to allow a gripping member 28 to be more easily applied. In some embodiments, the solvent may be applied to the gripping member 28. In yet other embodiments, a solvent may be applied to both the adhesive layer 14b of the vibration dampening tape 10 and to the gripping member 28. The solvent may be an alcohol-based solvent or a water-based solvent, or any other solvent known in the art suitable to lubricate an adhesive. The solvent does not penetrate or pass through the polymer layer 12. Thus, the solvent does not or does not substantially effect the tackiness of adhesive layer 14a attached to the surface of the sporting equipment.

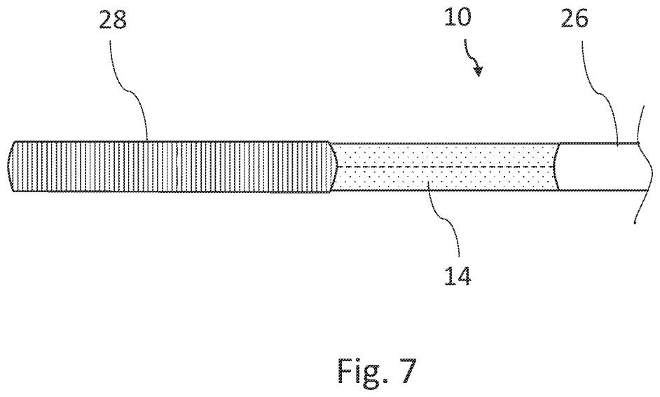

Once the solvent has been applied, the gripping member 28 may applied over the second adhesive layer 14b of the vibration dampening tape 10, as seen in FIG. 7. The gripping member 28 may be applied over the handle of a sports equipment to aid a user in maintaining a grip to the sports equipment. In some embodiments, the gripping member may have a textured or tacky outer surface for the user to hold. In some embodiments, the gripping member 28 may be an elongated strip that is wrapped around the second adhesive layer 14b. In other embodiments, the gripping member 28 may be a sleeve that is slid over the adhesive layer 14b. The sleeve may include a bore 27 for receiving the shaft 26. The sleeve may be made of real or synthetic leather, a polymer layer, synthetic polymer layer, or may be made of or contain the polymeric composition. The sleeve may be molded or cut into the desired sleeve shape. Optionally, the sleeve may include a core made of the polymeric composition and an outer layer made of a gripping material.

After the gripping member 28 is applied, the solvent is dried, returning the adhesive layer 14b to it tacky state and allowing the adhesive layer 14b to adhere to the inside surface of the gripping member 28. The solvent may be dried for a sufficient time for the adhesive layer 14b to return to its tacky state. For example, the solvent may be dried for at least an hour.

### Butyl Rubber

Butyl rubber is a copolymer of isobutylene with small amounts of isoprene. Butyl rubber in the uncured state is a weak material having the typical properties of a plastic gum; it has no definite elastic limit, that is, upon slow application of tensile stress, it elongates almost indefinitely without breaking, and exhibits virtually no elastic recovery after the stress is removed. On the other hand, vulcanized or cured butyl rubber is a strong, non-plastic material; it has an elastic limit, as well as the ability to return substantially to its original length after being stretched as much as several hundred percent.

In one embodiment of the present disclosure, the unsaturation in the butyl polymer or butyl rubber, which comes from the isoprene component, may simultaneously impart the dampening properties, as well as anti-ageing properties, and the anti-microbial properties of the polymeric formulation. In one embodiment, the range of unsaturation of the butyl rubber is 1.65-2.60 mole % unsaturation. In another embodiment, the unsaturation is from 0.7 mole % to 2-45 mole %. Although lower unsaturation would result in lower cross-link density, which might provide improved dampening, it may also deteriorate the stress/strain properties and set properties. In one embodiment, the butyl rubber is cross-linked with a phenol-formaldehyde resin cure or is sulfur crosslinked. Butyl rubber is well known in the art and is described in U.S. Pat. No. 3,031,423, column 1, lines 15 to 24. The low unsaturation butyl rubber may contain 0.5 to 1.1 mole % isoprene and 98.9 to 99.5 mole % isobutylene and can be prepared by any of the well-known prior art methods, e.g., as described in U.S. Pat. No. 2,356,128.

Alternatively, useful impact modifying rubbers include, for instance, thermoplastic elastomeric polymeric resins. Impact modifying rubbers may be selected from, for example, polybutadiene, polyisobutylene, ethylene-propylene copolymers, ethylene-propylene-diene terpolymers, sulfonated ethylene-propylene-diene terpolymers, polychloroprene, poly(2,3-dimethylbutadiene), nitrile-butadiene rubber (NBR), hydrogenated nitrile-butadiene rubber (HNBR), poly(butadiene-co-pentadiene), chlorosulfonated polyethylenes, polysulfide elastomers, block copolymers, made up of segments of glassy or crystalline blocks such as polystyrene, poly(vinyltoluene), poly(t-butylstyrene), polyester and the like and the elastomeric blocks such as polybutadiene, polyisoprene, ethylene-propylene copolymers, ethylene-butylene copolymers, polyether ester and the like as for example the copolymers in poly(styrene-butadiene-styrene) block copolymer manufactured by Shell Chemical Company under the trade name of KRATON.

In one embodiment, the butyl rubber is present in the composition in the range of from about 45% to 65% of the total weight of the formulation. Stated another way, the butyl rubber could be present by percent weight of the formulation as follows: 45; 45.5; 46; 46.5; 47; 47.5; 48; 48.5; 49; 49.5; 50; 50.5; 51; 51.5; 52; 52.5; 53; 53.5; 54; 54.5; 56; 56.5; 57; 57.5; 58; 58.5; 59; 59.5; 60; 60.5; 61; 61.5; 62; 62.5; 63; 63.5; 64; 64.5; and about 65. In another embodiment, the butyl rubber can be present in the composition in the following weight percent: 45; 45.1; 45.2; 45.3; 64.7; 64.8; 64.9; and 65. The butyl rubber content could be present in a range defined by any two numbers above.

### Phenol-Formaldehyde Resin

The curing agents may be phenols and phenol-formaldehyde resins produced by condensation of a phenol with formaldehyde in the presence of base. Typical agents include 2, 6-dihydroxymethyl-4-alkyl phenols and their polycyclic condensation polymers. Examples are given in U.S. Pat. No. 2,701,895. Curing occurs through the reaction of the methylol groups of the phenols or resin with the uncured rubber to form cross-linked structures.

In one embodiment, the polymeric composition is formed by curing the butyl rubbers with low amounts of phenol-formaldehyde resins with low levels of ether bridging. Such improved properties may include improved high-temperature ageing characteristics, faster cure rates, and better stress/strain properties. The polymeric composition may comprise such resin, an uncured butyl rubber, a halogen-containing compound and, optionally, a filler, and a process oil.

Base-catalyzed phenol-formaldehyde resins can be made by condensing a phenol with formaldehyde in the presence of base. The reaction results in the formation of phenol-alcohols which may subsequently undergo condensation reactions to form polycyclic phenols. An example of a polycyclic phenol-formaldehyde resin is given below:

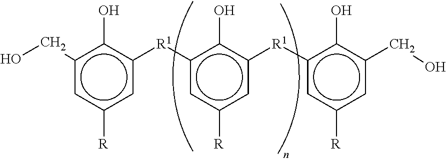

As shown, the phenol moieties are bridged by R′. These bridging moieties, R′, may be the same or different and may be either methylene (—CH2-) or dimethylene ether (—CH2-0-CH2). The integer n may have values from o to 10, preferably o to 5. It is preferred that the integer n has a value sufficiently high that the resin is a solid. The group R is an alkyl, cycloalkyl, cycloalkylalkyl, aryl or aralkyl group. It may contain up to about twelve carbon atoms. In one embodiment, the R groups are alkyl groups containing up to 8 carbon atoms, especially methyl, tert-butyl and tert-octyl groups; see U.S. Pat. No. 2,701,895 for further examples, which are in incorporated by reference herein.

Resin-cured butyl rubbers with improved properties may be obtained by curing with phenol-formaldehyde resins with low levels of ether bridging. In one embodiment, the molar ratio of dimethylene ether bridges to methylene bridges in the phenol-formaldehyde resin is less than about 2.5:1, or less than about 1.7:1, most preferably less than about 1:1. Examples of suitable phenol-formaldehyde resins which may be used include the resin in which has a molar ratio of dimethylene ether bridges to methylene bridges of about 0.65:1.

In one embodiment, the butyl rubber composition requires a small amount of a diene comonomer, usually isoprene, so that the composition can undergo cross-linking, or curing. Grades of butyl rubber can be distinguished by their isoprene content and Mooney viscosity (related to the molecular weight). Examples of uncured butyl rubber may have from about 0.5 mol % to about 10 mol % isoprene with butyl rubbers containing from about 0.5 to about 2.5 mol % isoprene, or also from about 0.9 to about 2.1 mol % of isoprene. Mention is made particularly of butyl rubber having about 1-4 to about 1.6 mol % isoprene. Some suitable butyl rubbers have a Mooney viscosity of about 25 to 70, preferably about 30 to about 63 (RPML 1+8 @125′C).

In one embodiment, a halogen is present in the formulation. Examples of halogen-containing compounds include organic compounds such as olefin-containing polymers having pendant chlorine atoms, such as polychloroprene, available under such trademarks as Baypren (Bayer), Butachlor (Distagul) and Neoprene (DuPont). In one embodiment, the amount present in the formulation is within the range of about 1 to about 10 parts, or about 4 to about 6 parts, or about 5 parts by weight to about 95 parts of uncured butyl rubber. Alternatively, chlorine-containing salts, for example stannous chloride, can be used as the halogen-containing compound. It is possible that the required halogen, e.g., chlorine or bromine, atom is provided as a component of one of the other ingredients of the formulation, rather than being provided by a separately added compound. For instance, it is possible to use a chlorinated or brominated butyl rubber, or a chlorinated or brominated polycyclic phenol-formaldehyde resin, rather than a separately added compound such as polychloroprene or stannous chloride. In one embodiment, the unhalogenated butyl rubber and unhalogenated phenol-formaldehyde resin are used and that the halogen is added in, say, polychloroprene or stannous chloride.

As an alternative to the PF resin, one could use a haloalkylated PF resin, such as bromomethylated PF resin. The range of alkylation in the alkyl PF resin is from about 8% to 12.5%. The bromomethyl alkylated phenolic resins are described in U.S. Pat. No. 2,972,600, the contents of which are incorporated herein by reference, and are prepared by brominating a phenolic material selected from the group consisting of 2-hydroxymethyl 4-alkyl phenols, 2,6-dihydroxymethyl 4-alkyl phenols, resitols of such hydroxymethyl 4-alkyl phenols wherein the resitol has an average of up to 4 phenol units, and a mixture of a 4-alkyl phenol with 0.5 to 2.1 moles of formaldehyde per mole of said phenol, said alkyl group containing 4 to 20 carbon atoms and the average bromine content of the brominated material being from about 1 to about 9 percent.

In one embodiment, a low unsaturation butyl rubber containing a bromomethyl alkylated phenolic resin and a metal halide is used.

In one embodiment, the PF resin is present in the composition in the range of from about 5% to 15% of the total weight of the formulation. Stated another way, the PF resin could be present by percent weight of the formulation as follows: 5; 5.5; 6; 6.5; 7; 7.5; 8; 8.5; 9; 9.5; 10; 10.5; 11; 11.5; 12; 12.5; 13; 13.5; 14; 14.5; and 15.

In another embodiment, the PF resin can be present in the composition in the following weight percent: 5; 5.1; 5.2; 5.3; 14.7; 14.8; 14.9; and 15. The PF resin content could also be present in a range defined by any two numbers above.

### Other Curing Agents

Butyl rubber compositions may also be crosslinked in a number of different ways. Sulfur both in the form of rubber makers sulfur (S8) or polymeric sulfur (insoluble sulfur) (Sx) along with various accelerators such as Thiazoles, Sulfenamides, Guanidines, Carbamates, Thiurams, Alkyl phenol disulfides, Thiomorpholines, Dioximes, Phosphorodithioates, Aniline and its derivatives.

Halogenated butyl rubbers including brominated isobutylene-co-para-methylstyrene (BIMSM) may also be used. Halogenated butyl rubber may also be crosslinked by thioureas, metal oxides or metal chlorides, or peroxides with co-agents.

### Fillers

Fillers may be added to the formulation. Examples of fillers include talc, calcium carbonate, clay, silica, titanium dioxide, carbon black, aluminum silicate, hydrated aluminum silicate, kaolin, montmorillonite, calcium carbonate, and quartz.

The carbon black ranges from N-770 to N-110; in one embodiment, the carbon black is N-351, classified in accordance with ASTM D1765 (see Maurice Morton, “Rubber Technology” 3rd Edition, Chapman & Hall, New York, 1995, pages 69-70, hereby incorporated by reference). In another embodiment, the carbon black is N550.

In one embodiment, the filler is present in the amount of about 5% to about 45% of the total weight of the formulation. In another embodiment, more than one filler may be present with each filler in the amount of about 5% to about 45% of the total weight of the formulation. Stated another way, the filler could be present by percent weight of the formulation as follows: 5; 5.5; 6; 6.5; 7; 7.5; 8; 8.5; 9; 9.5; 10; 10.5; 11; 11.5; 12; 12.5; 13; 13.5; 14; 14.5; 15; 15.5; 16; 16.5; 17; 17.5; 18; 18.5; 19; 19.5; 20; 20.5; 21; 21.5; 22; 22.5; 23; 23.5; 24; 24.5; 25; 25.5; 26; 26.5; 27; 27.5; 28; 28.5; 29; 29.5; 30; 30.5; 31; 31.5; 32; 32.5; 33; 33.5; 34; 34.5; 35; 35.5; 36; 36.5; 37; 37.5; 38; 38.5; 39; 39.5; 40; 40.5; 41; 41.5; 42; 42.5; 43; 43.5; 44; 44.5; and 45.

In another embodiment, the filler or fillers individually can be present in the composition in the following weight percent: 5; 5.1; 5.2; 5.3, 44.7; 44.8; 44.9; and 45.

In one embodiment, the formulation contains more than one filler. In one embodiment the first filler is present in the formulation in the range of from about 5% to about 15% of the weight of the formulation. In the embodiment, where the second filler is present, the second filler is present in the range of from about 20% to 35% of the weight of the formulation.

The formulation of the filler may contain a process oil, and many suitable process oils are known to those skilled in the art. Examples of suitable process oils include castor oil and paraffinic oils.

Zinc oxide may be added as an activator, suitably in an amount of up to about 8 parts, preferably about 5 parts, per hundred parts of rubber. Stearic acid may also be added, to assist in solubilizing the zinc oxide in the formulation.

The butyl rubber formulation described may be made by mixing the components of the butyl rubber formulation described above, and additionally any other desired optional ingredients such as accelerator, extender, lubricant, plasticizer, and the like, in any convenient manner used in the rubber industry, e.g. on a mill or in an internal mixer.

Vulcanizates can be made from the formulation by converting the formulation to any desired shape and size and vulcanizing at elevated temperatures.

In another aspect, the formulation includes uncured butyl rubber, a halogen-containing compound, and a polycyclic phenol-formaldehyde resin having dimethylene ether bridges and methylene bridges, wherein the molar ratio of dimethylene ether bridges to methylene bridges is less than about 2.5:1 and the ratio of uncured butyl rubber to said polycyclic phenol-formaldehyde resin is less than 10:1 and may be as little as 5:1.

The product can be formulated to facilitate formation of strips, sheets, tapes, rolls, films, forms, foams, molds, slabs, tapes, coatings, perforated sheets, corrugated structures, laminates, beads, spray foams and any desired shape for damping purposes.

In one aspect, a vibration dampening composition comprises a carbon containing nano-material. In yet another aspect, a multilayer article comprises a vibration damping composition comprising a carbon containing nano-material.

In other embodiments, the compositions described herein may comprise a plurality of carbon containing nano-materials.

The carbon containing nano-materials used are not particularly limited. Carbon nanotubes may be single-walled carbon nanotubes (SWCNT) or double walled carbon nanotubes (DWCNT). The DWCNTs may be obtained by any means, including, for instance, catalytic chemical vapor deposition. Such preparations techniques may give approximately 80% DWCNTs, having a diameter ranging between 1 and 3 nm and a length that can reach 100 μm. The electrical conductivity of such nanotubes may be greater than 25 S/cm when they are pressed into the form of pellets.

Other carbon nanotubes include multi-walled nanotubes (MWCNTs). The MWCNTs may be obtained by vapor deposition in the presence of a supported catalyst, such as described in PCT published patent application WO03/002456A2. MWCNTs so prepared may show, by transmission electron microscopy, that close to 100% of the tubes are MWCNTs. Such MWCNTs may have a diameter ranging between 10 and 50 nm and a length that can attain 70 μm. The electrical conductivity of such MWCNTs may reach greater than 20 S/cm when pressed in the form of pellets.

The SWCNTs, DWCNTs, and MWCNTs may be purified by washing with acid solution (such as sulfuric acid and hydrochloric acid) so as to rid them of residual inorganic and metal impurities. SWCNTs may also be noncovalently modified by encasing the nanotubes within cross-linked, amphiphilic copolymer micelles, such as described by Kang and Taton in Journal of the American Chemical Society, vol. 125, 5650 (2003). In another embodiment, the carbon nanotubes may be surface-functionalized, for instance, as described by Wang, Iqbal, and Mitra in Journal of the American Chemical Society, vol. 128, 95 (2006).

Other carbon containing nano-materials include, for instance, carbon nanofibers.

An example of suitable nanofibers include sub-micron VaporGrown Carbon Fibers (s-VGCF) with very small diameters (20-80 nm), high aspect ratio (>100), and a highly graphitic structure (>60%) available as Grupo Antolin Carbon Nanofibers (GANF), from Grupo Antolin, Spain.

Alternatively, Pyrograf®-III is available in diameters ranging from 70 and 200 nanometers and a length estimated to be 50-100 microns available from Applied Sciences, Inc. (ASI) located in Cedarville, Ohio.

In yet further embodiments, the vibration dampening compositions described herein may further comprise non-carbon containing nano-materials. Such materials include, for instance, silica nano-particles, zirconia nano-particles, and alumina nano-particles, Ti02, clay, indium tin(oxide), iron oxide, zinc oxide, and combinations thereof.

The compositions described herein may further comprise pigments, flow control additives, anti-oxidants, curative compounds, co-curatives, cure accelerators, inert fillers such as mineral fillers, flame retardants, processing aids such as extrusion aids (including fluoropolymer-based processing aids and lubricants such as mineral oils and waxes), glass bubbles, polymeric bubbles (such as Dualite® Hollow Composite Microsphere Fillers available from Pierce and Stevens, Corp., Buffalo, N.Y.) and other additives.

Shaped articles may also be formed which comprise a carbon containing nano-material; a curable matrix; and a block copolymer comprising a functional block and a non-functional block, wherein no block is compatible with the curable matrix. In these shaped articles, the carbon containing nano-materials may be dispersed in the curable matrix. In some embodiments, the curable matrix is electrically non-conductive, whereas the composite article itself is electrically conductive.

Shaped articles include, for instance, sleeves, shafts, handles, frames, struts, bodies and the like. In some embodiments, the compositions described herein allow for efficient and/or uniform dispersion of carbon containing nano-materials. This efficient dispersion may give rise to favorable properties, such as tensile strength, modulus improvements, flexibility, electrical conductivity, 5 thermal conductivity, and viscoelastic vibration damping.

In some embodiments, the cured compositions described herein have a tan delta value that is at least 20% higher than a comparable cured composition containing the cured matrix that lacks the carbon containing nano-materials as described herein. In other embodiments, the tan delta value of the cured compositions described herein is increased by 20% or more, 25% or more, 35% or more, or even 50% or more when compared to a cured composition containing the cured matrix that lacks the carbon containing nano-materials and block copolymer as described herein.

The polymeric compositions also may have antimicrobial properties. Thus, the formulation in one or more of the shapes desired can be used for dampening and impact modification as well as for additional microbial resistance this material has to offer. This material also in one embodiment has light-weight compared to the comparable product in the market as well as longer useful life.

Generally speaking, the polymeric composition offers one or more of the following physical characteristics in its use: impact dampening; sound dampening; vibration dissipation; cushioning for comfort; sound attenuation; light weight; longer life; anti-microbial properties; resistance to air exposure; and UV resistance.

The use of the polymeric composition can be envisioned in a variety of fields. Some of the examples include grips for sporting equipment (tennis rackets, golf clubs, hockey sticks, mouth guards, football helmets, etc.), seats (for motorcycles or chairs), footwear (including shoe soles, inserts, toe pads, etc.), electronics (computers, cell phones, disk drives, etc.), vehicles, automobile interiors and roofs, kitchen appliances, outboard motors, braking systems, medical devices, etc. Further applications include automotive under hood insulation, automotive floor panels, bench top laboratory equipment, building wall panels, cell phone cases, compressor motors, coatings, computer pads, dishwasher walls, percussion (drum) dampeners, films, optical equipment, (laser), integrated components, medical devices, seat cushions, slab stock.

For example, from physical properties' standpoint of the polymeric composition, the following exemplary applications are identified:

### Vibration

I. Bench top laboratory equipment isolation
II. Golf Club Impact
Ill. Tennis Rackets Impact
IV. Football Helmets
V. Integrated systems manufacturers
VI. Seat Cushions Sound
VII. Building Wall Panels
VIII. Compressor Motors
IX. Dishwasher Walls
X. Drum Dampeners
XI. Textiles and Surfaces
XII. Anti-microbial coatings or surfaces/disposable anti-microbial textiles

### Experimental-Evaluation of Damping Properties

Several samples were analyzed using the Dynamic Mechanical Analyzer (DMA) to determine their tan A (tan delta) value, that is, the ratio of loss modulus E″ to storage modulus E′:
1. Material of the REB5A-55 with durometer A hardness of 55
2. Material of the REB5A-45 with durometer A hardness of 45
3. Comparative material-Otter Box phone case
4. Comparative material-Belkin phone case
5. Comparative material-Wilson yellow mouth guard
6. Comparative material-Riddell helmet and protective gear—black foam
7. Comparative material-Spalding neoprene material—black with blue backing square material
8. Comparative material-Moon Gel damper pad
9. Comparative material Sorbothane 0208060-50-10 (50 durometer hardness)

The REB5A materials were tested at two different hardness values (45 and 55 durometer A) and compared with materials available on market from competitors. Seven materials were tested for comparison purposes. The primary objective of the test was to obtain tan 6 and E′ values from the nine samples at vibration frequencies of 10 Hz, 20 Hz, 50 Hz, and 100 Hz at room temperature (26±1° C.) using the DMA. These measurements were reported on the technical data sheets of competitive products. Tan δ, also known as damping factor in DMA terminology, is generally related to the energy damping properties of the material being tested. E′ is the storage modulus and is related to the stiffness of the material. Tan d measures the ratio of the loss modulus E″ to the storage modulus E′.

A Netzch 242 DMA was used in the tensile mode. Static force of 0 N and dynamic force of 5 N were used with a force factor of 1.01 and an amplitude of 50 μm. Testing was conducted at room temperature (26±1° C.) at frequencies of 10 Hz, 20 Hz, 50 Hz, and 100 Hz. Table 1 provides a summary of the DMA results; the results have been listed in order of highest to lowest tan 8 values. Table 2 calculates the percentage improvement in tan delta values of the materials of the present disclosure over the comparative materials.

The proprietary material at 45 and 55 durometer A hardness (REB5A-45 and REB5A-55) provided the highest tan 8 values out of all of the tested samples. Thus, these materials would have superior mechanical energy damping properties at the tested conditions.

The storage modulus E′ of the materials corresponded well with the physical stiffness of the samples. On the other hand, this stiffness represented by E′ did not seem to correlate directly to the damping performance represented by tan δ. For example, a less stiff material (lower E′ value) did not correspond to a higher level of damping (high tan δ value) as may be conventionally expected.

TABLE 1

| | | Storage Modulus E′(MPa) | | | | Tan Delta | | | |
|---|---|---|---|---|---|---|---|---|---|
| | Sample | 10 | 20 | 50 | 100 | | 20 | 50 | 100 |
| No. | Description | Hz | Hz | Hz | Hz | Hz | Hz | Hz | Hz |
| 1. | REB5A-55 | 10.187 | 11.569 | 13.875 | 16.692 | 0.516 | 0.586 | 0.709 | 0.832 |
| 2. | REB5A-45 | 7.164 | 7.908 | 9.144 | 10.435 | 0.415 | 0.467 | 0.581 | 0.708 |
| 3. | Sorbothane | 0.821 | 0.896 | 1.002 | 0.877 | 0.275 | 0.312 | 0.476 | 0.590 |
| | 0208060-50-10 | | | | | | | | |
| 4. | Moon Gel damper | 0.188 | 0.188 | 0.177 | 0.069 | 0.099 | 0.109 | 0.309 | 0.455 |
| | pads | | | | | | | | |
| 5. | Spalding neoprene | 0.959 | 0.974 | 1.002 | 0.771 | 0.178 | 0.175 | 0.272 | 0.298 |
| 6. | Riddell helmet and | 0.615 | 0.622 | 0.628 | 0-440 | 0.127 | 0.130 | 0.244 | 0.265 |
| | protective gear | | | | | | | | |
| 7. | Belkin phone case | 51.782 | 54.164 | 57.565 | 61.087 | 0.136 | 0.144 | 0.171 | 0.203 |
| 8. | Otter Box phone | 13.360 | 13.979 | 14.906 | 15.635 | 0.126 | 0.131 | 0.159 | 0.195 |
| | case | | | | | | | | |
| 9. | Wilson yellow | 10.683 | 11.145 | 11.832 | 12.290 | 0.117 | 0.117 | 0.138 | 0.162 |
| | mouth guard | | | | | | | | |

TABLE 2
Percent Improvement in Tan Delta of
REB5A-45 Over Comparative Samples

| | | % Improvement in Tan Delta Over | | | |
|---|---|---|---|---|---|
| | | Commercial Samples | | | |
| No. | Sample Description | 10 Hz | 20 Hz | so Hz | 100 Hz |
| 3. | Sorbothane (Hardness 50) | 87.6 | 87.8 | 48.9 | 41.0 |
| 4. | Moon Gel damper pad | 421.0 | 437.6 | 129.4 | 82.9 |
| 5. | Spalding neoprene | 187.9 | 234.8 | 160.7 | 179.2 |
| 6. | Riddell helmet | 306.3 | 350.8 | 190.6 | 214.0 |
| 7. | Belkin phone case | 278.4 | 306.9 | 314.6 | 309.9 |
| 8. | Otter Box phone case | 309.5 | 347.3 | 365.9 | 326.7 |
| 9. | Wilson mouth guard | 341.0 | 400.8 | 413.8 | 413.6 |

TABLE 3
Percent Improvement in Tan Delta of
REB5A-45 Over Comparative Samples

| | | % Improvement in Tan Delta Over | | | |
|---|---|---|---|---|---|
| | | Commercial Samples | | | |
| No. | Sample Description | 10 Hz | 20 Hz | 50 Hz | 100 Hz |
| 3. | Sorbothane (Hardness 50) | 50.9 | 49.7 | 22.1 | 20.0 |
| 4. | Moon Gel damper pad | 319.2 | 328.4 | 88.0 | 55.6 |
| 5. | Spalding neoprene | 133.1 | 166.9 | 113.6 | 137.6 |
| 6. | Riddell helmet | 226.8 | 259.2 | 138.1 | 167.0 |
| 7. | Belkin phone case | 205.1 | 224.3 | 239.8 | 248.8 |
| 8. | Otter Box phone case | 229.4 | 256.5 | 265.4 | 263.0 |
| 9. | Wilson mouth guard | 254.7 | 299.1 | 321.0 | 337.0 |

What is claimed is:

1. A sports equipment comprising:
a shaft with a proximal end and a distal end;
a handle located at the proximal end of the shaft;
a gripping member placed over the handle; and
a vibration dampening element comprising a vibration dampening polymer layer, wherein the vibration dampening element is located between the handle and the gripping member.

2. The sports equipment of claim 1, wherein the vibration dampening polymer layer comprises butyl rubber.

3. The sports equipment of claim 1, wherein the vibration dampening element comprises a layered strip or sheet.

4. The sports equipment of claim 1, wherein the polymer layer comprises a first opposing side and a second opposing side.

5. The sports equipment of claim 4, wherein the vibration dampening element comprises a vibration dampening tape having at least one adhesive layer.

6. The sports equipment of claim 5, wherein the adhesive layer is a double-sided adhesive or a double sided paper-based adhesive.

7. The sports equipment of claim 5, wherein the vibration dampening element comprises a first adhesive layer over the first opposing side of the polymer layer and a second adhesive layer over the second opposing side of the polymer layer.

8. The sports equipment of claim 1, wherein the polymer layer further comprises a phenol-formaldehyde resin.

9. The sports equipment of claim 8, wherein the phenol-formaldehyde resin is in a range of from about 5% to about 15% by weight of the polymer layer.

10. The sports equipment of claim 8, wherein the phenol-formaldehyde resin comprises a bromomethylated alkyl phenol-formaldehyde resin.

11. The sports equipment of claim 1, wherein the polymer layer further comprises at least one filler.

12. The sports equipment of claim 11, wherein the at least one filler is in a range of from about 5% to about 45% by weight of the polymer layer.

13. The sports equipment of claim 11, wherein the filler is selected from talc, calcium carbonate, clay, silica, titanium dioxide, carbon black, aluminum silicate, hydrated aluminum silicate, kaolin, montmorillonite, calcium carbonate, quartz, and mixtures thereof.

14. The sports equipment of claim 1, wherein the polymer layer has a shore A hardness in a range of from about 35 to about 65.

15. The sports equipment of claim 1, wherein the polymer layer has a loss factor greater than 0.30 at 10 Hz and 0.60 at 100 Hz, wherein said loss factor is measured as a ratio of loss modulus and storage modulus in a dynamic mechanical analysis.

16. The sports equipment of claim 2, wherein the butyl rubber is in a range of from about 45% to about 65% by weight of the polymer layer.

17. The sports equipment of claim 2, wherein said butyl rubber is an isobutylene/isoprene rubber.

18. The sports equipment of claim 1, wherein the polymer layer further comprises stearic acid.

19. A golf club comprising:
a shaft with a proximal end and a distal end;
a handle located at the proximal end of the shaft;
a club located at the distal end of the shaft;
a gripping member placed over the handle; and
a vibration dampening element comprising a vibration dampening polymer layer, wherein said vibration dampening element is located between the handle and gripping member.

20.-37. (canceled)

38. A method for applying a gripping member to a sports equipment comprising:
applying a vibration dampening tape to a handle of the sports equipment, wherein the vibration dampening tape comprises:
a polymer layer comprising a vibration dampening polymer and a first and second opposing side;
a first adhesive layer over the first opposing side of the polymer layer, wherein the first adhesive layer is configured to adhere to the handle of the sports equipment; and
a second adhesive layer over the second opposing side of the polymer layer, wherein the second adhesive layer is configured to adhere to the gripping member;
applying a solvent to the vibration dampening tape;
sliding the gripping member over the vibration dampening tape; and
drying the solvent to adhere the vibration dampening tape to an inside surface of the gripping member.

39.-52. (canceled)
